(19) United States
(12) Patent Application Publication
(10) Pub. No.: US 2006/0013265 A1
(43) Pub. Date: Jan. 19, 2006

(54) Bus architecture and data transmission method thereof

(75) Inventors: Tian-Bao Hu, Macau (TW); Chung-Ren Yang, Taipei (TW); Li-Chien Chen, Taipei (TW)

Correspondence Address: THE LAW OFFICES OF MIKIO ISHIMARU, 1110 SUNNYVALE-SARATOGA ROAD, SUITE A1, SUNNYVALE, CA, 94087, US

(73) Assignee: CULTURE.COM TECHNOLOGY (MACAU) LTD., Macau (MO)

(21) Appl. No.: 10/892,264

(22) Filed: Jul. 14, 2004

(51) Int. Cl. H04J 3/04

(52) U.S. Cl. 370/535

(57) ABSTRACT

A bus architecture and a data transmission method thereof are applicable to a signal transmission environment between functioning components of an information system, so as to transmit data, addresses and/or control signals between any two of the functioning components of the information system in a serial transmission manner via at least one wire. During the data transmission method, the bus architecture can convert a parallel signal to a serial signal and/or convert a serial signal to a parallel signal, and the sequence of the two conversions being performed or the proceeding of only one or both of the conversions depends on practical requirements.

### FIELD OF THE INVENTION

The present invention relates to signal transmission technologies, and more particularly, to a bus architecture and a data transmission method thereof, for use in a signal transmission environment between functioning components of an information system, so as to transmit data, addresses and control signals between any two of the functioning components in a serial transmission via at least one wire; during the data transmission method, the bus architecture can perform conversion between a parallel signal and a serial signal depending on practice requirements.

### BACKGROUND OF THE INVENTION

With respect to an information system (such as a computer), a bus refers to a linking channel used to transmit a signal from one place to another between functioning components (such as units, elements, components and devices) of the information system. Generally, the bus comprises a set of parallel wires connected to the units of the information system and serves as a communication path between the units so as to transmit data from one unit to another. These units include processors, memories, input/output systems and peripheral devices for the information system.

The bus facilitates cooperation of a complex system and comprises a local bus and a global bus. The local bus connects a memory and an input/output device to a specific processor, such that a bandwidth between the processor and the memory can be effectively utilized, and thus the local bus relates to the structure of the processor. The global bus is connected to a number of processors and operates based on maximum efficiency between sub-systems. The global bus usually performs message coordination or transmission, allowing data to be exchanged between different processors in the system.

For a personal information system, buses can be divided into three groups based on names and designs thereof. 1. Data bus, which is an electronic channel for connecting a central processing units (CPU), a memory and other hardware devices on a motherboard together, and comprises a set of parallel wires. The speed of transmitting data between hardware depends on the number of data wires. Generally, the data bus may have 8 wires for transmitting 8 bits at a time, or 16 wires for transmitting 16 bits at a time. Along with the advancement of processor technology, an amount of data received and transmitted at a time by a chip of the processor is also increased, such that a buffer is provided to control the direction and amount of data flows between the processor and the memory or between the processor and the input/output device. 2. Address Bus, which comprises a set of data wires similar to those of the data bus and for transmitting memory addresses. 3. Control bus, which serves to transmit control signals and directly controls the memory or the input/output device.

In the conventional personal information system, all the data bus, address bus and control bus each comprises a set of wires such as 8 or 16 wires. The type of data transmission of the data bus, the type of address data transmission of the address bus, and the type of control signal transmission of the control bus all belong to parallel data transmission. As the processor technology progresses, the buffer is usually provided to integrate transmission of data, addresses and control signals between the processor and other hardware devices on the motherboard. However, with a growing increase in functions of the processor while a restricted increase in the number of leads, how to effectively utilize the leads is a problem to be highly concerned. Furthermore, serial data transmission can somehow achieve a relatively high data transmission speed, for example, above 1.5 gigabytes (GB) per second.

Therefore, the problem to be solved here is to provide a bus architecture and a data transmission method thereof, such that no buffer is required for transmitting data, addresses and control signals between any two functioning components of the information system, and between the processor, the memory and other hardware devices on the motherboard, and the parallel transmission type of the data bus, address bus and control bus is not necessary, as well as the number of leads of the data bus, address bus and control bus that are connected to the processor can be reduced in the condition with a growing increase in functions of the processor while a restricted increase in the number of leads.

### SUMMARY OF THE INVENTION

In light of the above prior-art drawbacks, a primary objective of the present invention is to provide a bus architecture and a data transmission method thereof, for use in a signal transmission environment between functioning components such as units, elements, components and devices of an information system, so as to transmit data, addresses and/or control signals between any two functioning components of the information system in a serial transmission manner via at least one. wire.

Another objective of the present invention is to provide a bus architecture and a data transmission method thereof, whereby during the data transmission method, the bus architecture can convert a parallel signal to a serial signal and/or convert a serial signal to a parallel signal, and the sequence of the two conversions being performed or the proceeding of only one or both of the conversions depends on practical requirements.

A further objective of the present invention is to provide a bus architecture and a data transmission method thereof, so as to reduce the number of leads of a data bus, an address bus and a control bus that are connected to a processor.

In accordance with the above and other objectives, the present invention proposes a bus architecture and a data transmission method thereof. The bus architecture comprises a parallel to serial signal converting module and a serial to parallel signal converting module.

During the data transmission method, the bus architecture can convert a parallel signal to a serial signal and/or convert a serial signal to a parallel signal, and the sequence of the two conversions being performed or the proceeding of only one or both of the conversions depends on practical requirements. When the parallel signal is converted to the serial signal by the bus architecture, the parallel to serial signal converting module converts the inputted parallel signal of at least one data, address, or control signal wire to the serial signal that is subsequently outputted. On the other hand, the inputted serial signal of a single data, address, or control signal wire is converted to the parallel signal that is subsequently outputted.

The parallel to serial signal converting module and the serial to parallel signal converting module of the bus architecture in the present invention can be internally constructed in the information system during fabrication of the information system, or can be made as external circuits to be combined with the units, elements, components and devices of the information system.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram showing a systemic basic structure of a bus architecture according to the present invention;

FIG. 2 is a flowchart showing a set of procedural steps of a data transmission method applicable to the bus architecture shown in FIG. 1;

FIG. 3 a flowchart showing another set of procedural steps of the data transmission method applicable to the bus architecture shown in FIG. 1;

FIG. 4 is a flowchart showing a further set of procedural steps of the data transmission method applicable to the bus architecture shown in FIG. 1;

FIG. 5 is a flowchart showing a further set of procedural steps of the data transmission method applicable to the bus architecture shown in FIG. 1;

FIG. 6 is a flowchart showing a further set of procedural steps of the data transmission method applicable to the bus architecture shown in FIG. 1;

FIG. 7 is a flowchart showing a further set of procedural steps of the data transmission method applicable to the bus architecture shown in FIG. 1; FIG. 8 is a block diagram showing a basic structure of a parallel to serial signal converting module of the bus architecture shown in FIG. 1 according to a preferred embodiment of the present invention;

FIG. 9 is a block diagram showing a basic structure of a serial to parallel signal converting module of the bus architecture shown in FIG. 1 according to a preferred embodiment of the present invention;

FIG. 10 is a block diagram showing a basic structure of a digital circuit shown in FIG. 9;

FIG. 11 is a schematic diagram showing cycles of CLK1 to CLK7 shown in FIG. 10;

FIG. 12 is a block diagram showing a basic structure of the parallel to serial signal converting module of the bus architecture shown in FIG. 1 according to another preferred embodiment of the present invention;

FIG. 13 is a schematic diagram showing wave alterations of CLK and parallel loaded (PL) signal, and each output of JK-flip flops;

FIG. 14 is a block diagram showing a basic structure of the serial to parallel signal converting module of the bus architecture shown in FIG. 1 according to another preferred embodiment of the present invention;

FIG. 15 is a schematic diagram showing timing of the serial to parallel signal converting module shown in FIG. 14;

FIG. 16 is a block diagram showing a basic structure of the parallel to serial signal converting module of the bus architecture shown in FIG. 1 according to a further preferred embodiment of the present invention;

FIG. 17 is a block diagram showing a basic structure of a digital circuit shown in FIG. 16;

FIG. 18 is a schematic diagram showing application of the bus architecture according to a preferred embodiment of the present invention;

FIG. 19 is a flowchart showing a set of procedural steps of a data transmission method applicable to the bus architecture shown in FIG. 18;

FIG. 20 is a schematic diagram showing application of the bus architecture according to another preferred embodiment of the present invention; and

FIG. 21 is a flowchart showing a set of procedural steps of a data transmission method applicable to the bus architecture shown in FIG. 20.

### DETAILED DESCRIPTION OF THE PREFERRED EMBODIMENTS

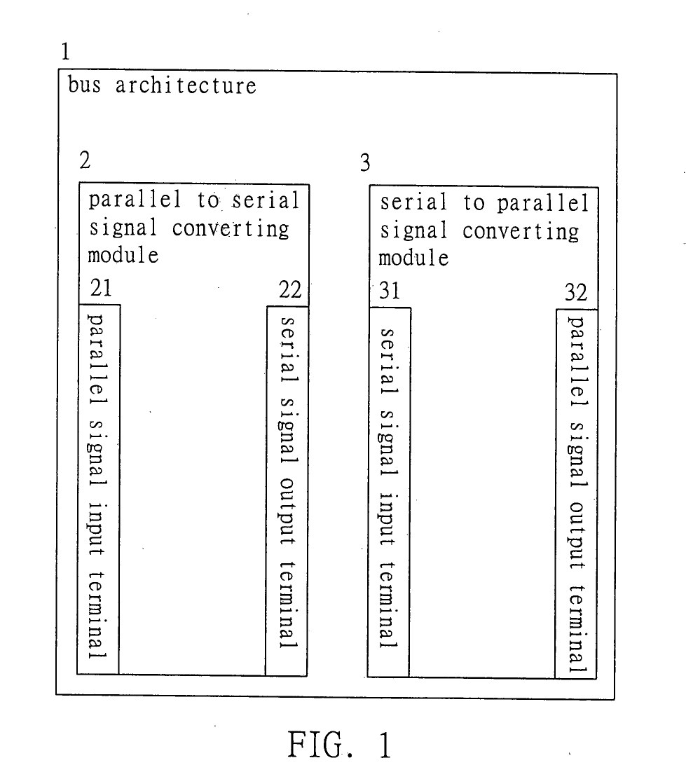

The preferred embodiments of a bus architecture and a data transmission method thereof proposed in the present invention are described in detail with reference to FIGS. 1 to 21.

FIG. 1 is a block diagram showing a systemic basic structure of the bus architecture according to the present invention. As shown in FIG. 1, the bus architecture 1 comprises at least one parallel to serial signal converting module 2 and at least one serial to parallel signal converting module 3. The parallel to serial signal converting module 2 comprises a parallel signal input terminal 21 and a serial signal output terminal 22. The serial to parallel signal converting module 3 comprises a serial signal input terminal 31 and a parallel signal output terminal 32. The parallel to serial signal converting module 2 can be directly connected to the serial to parallel signal converting module 3 by the means of the parallel signal input terminal 21 and the parallel signal output terminal 32, and/or by the means of the serial signal output terminal 22 and the serial signal input terminal 31, and/or by the means of at least one wire, wherein the wire may be a data wire, an address wire and/or a control signal wire.

When the bus architecture 1 performs conversion of a parallel signal to a serial signal, a parallel signal of at least one data wire, address wire or control signal wire is inputted to the parallel signal input terminal 21. The parallel to serial signal converting module 2 converts the inputted parallel signal to a serial signal that is then outputted by the serial signal output terminal 22. The outputted serial signal can be transmitted to an information system (not shown) or to the serial signal input terminal 31 via a data wire, an address wire or a control signal wire. The inputted parallel signal of at least one data wire, address wire or control signal wire to the parallel to serial signal converting module 2 can be obtained from the information system or from the parallel signal output terminal 32 of the serial to parallel signal converting module 3.

When the bus architecture 1 performs conversion of a serial signal to a parallel signal, a serial signal of a data wire, address wire or control signal wire is inputted to the serial signal input terminal 31 of the serial to parallel signal converting module 3. The serial to parallel signal converting module 3 converts the inputted serial signal to a parallel signal that is then outputted by the parallel signal output terminal 32. The outputted parallel signal can be transmitted to the information system or to the parallel signal input terminal 21 of the parallel to serial signal converting module 2 via at least one data wire, address wire or control signal wire. The inputted serial signal of a data wire, address wire or control signal wire to the serial to parallel signal converting module 3 can be obtained from the information system or from the serial signal output terminal 22 of the parallel to serial signal converting module 2.

The parallel to serial signal converting module 2 and/or the serial to parallel signal converting module 3 of the bus architecture 1 can be internally constructed in the information system during fabrication of functioning components of the information system, or can be made as external circuits to be combined with the information system. The functioning components include, for example, central processing units (CPU), micro processing units (MCU), electronic book card controllers, display controllers and display panels (all not shown).

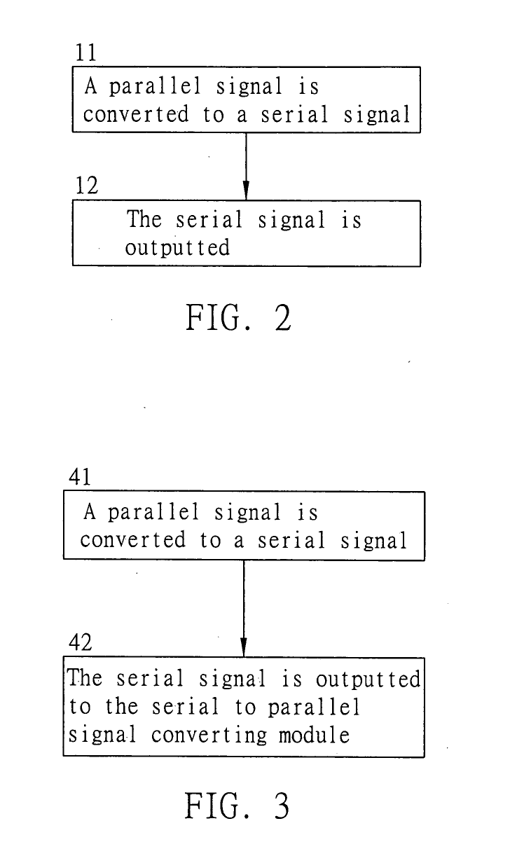

FIG. 2 is a flowchart showing a set of procedural steps of a data transmission method applicable to the bus architecture shown in FIG. 1. In this embodiment, the bus architecture 1 serves to convert a parallel signal to a serial signal. Referring to FIG. 2, in Step 11, a parallel signal of at least one data wire, address wire or control signal wire is inputted to the parallel signal input terminal 21 of the parallel to serial signal converting module 2, and the parallel to serial signal converting module 2 converts the inputted parallel signal to a serial signal. The inputted parallel signal of at least one data wire, address wire or control signal wire to the parallel to serial signal converting module 2 can be obtained from the functioning components of the information system or from the parallel signal output terminal 32 of the serial to parallel signal converting module 3. Then it proceeds to Step 12.

In Step 12, the serial signal output terminal 22 of the parallel to serial signal converting module 2 outputs the converted serial signal to the information system via at least one data wire, address wire or control signal wire.

FIG. 3 is a flowchart showing another set of procedural steps of the data transmission method applicable to the bus architecture 1 shown in FIG. 1. In this embodiment, the bus architecture 1 serves to convert a parallel signal to a serial signal. Referring to FIG. 3, in Step 41, a parallel signal of at least one data wire, address wire or control signal wire is inputted to the parallel signal input terminal 21 of the parallel to serial signal converting module 2, and the parallel to serial signal converting module 2 converts the inputted parallel signal to a serial signal. The inputted parallel signal of at least one data wire, address wire or control signal wire to the parallel to serial signal converting module 2 can be obtained from the functioning components of the information system or from the parallel signal output terminal 32 of the serial to parallel signal converting module 3. Then it proceeds to Step 42.

In Step 42, the serial signal output terminal 22 of the parallel to serial signal converting module 2 outputs the converted serial signal to the serial signal input terminal 31 of the serial to parallel signal converting module 3 via a data wire, address wire or control signal wire.

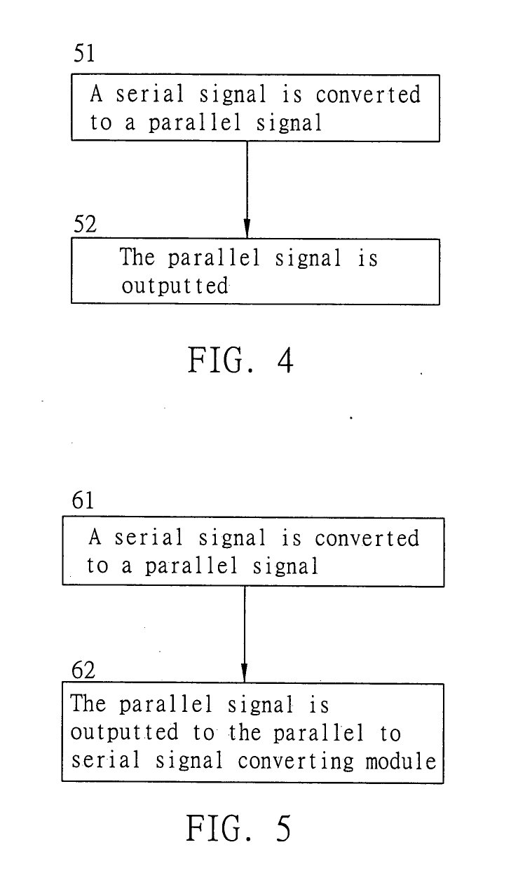

FIG. 4 is a flowchart showing a further set of procedural steps of the data transmission method applicable to the bus architecture 1 shown in FIG. 1. In this embodiment, the bus architecture 1 serves to convert a serial signal to a parallel signal. Referring to FIG. 4, in Step 51, a serial signal of a single data wire, address wire, or control signal wire is inputted to the serial signal input terminal 31 of the serial to parallel signal converting module 3, and the serial to parallel signal converting module 3 converts the inputted serial signal to a parallel signal. The inputted serial signal of a single data wire, address wire, or control signal wire to the serial to parallel signal converting module 3 can be obtained from the functioning components of the information system or from the serial signal output terminal 22 of the parallel to serial signal converting module 2. Then it proceeds to Step 52.

In Step 52, the parallel signal output terminal 32 of the serial to parallel signal converting module 3 outputs the converted parallel signal the information system via at least one data wire, address wire, or control signal wire.

FIG. 5 is a flowchart showing a further set of procedural steps of the data transmission method applicable to the bus architecture shown in FIG. 1. In this embodiment, the bus architecture 1 serves to convert a serial signal to a parallel signal. Referring to FIG. 5, in Step 61, a serial signal of a single data wire, address wire, or control signal wire is inputted to the serial signal input terminal 31 of the serial to parallel signal converting module 3, and the serial to parallel signal converting module 3 converts the inputted serial signal to a parallel signal. The inputted serial signal of a single data wire, address wire, or control signal wire to the serial to parallel signal converting module 3 can be obtained from the functioning components of the information system or from the serial signal output terminal 22 of the parallel to serial signal converting module 2. Then it proceeds to Step 62.

In Step 62, the parallel signal output terminal 32 of the serial to parallel signal converting module 3 outputs the converted parallel signal to the parallel signal input terminal 21 of the parallel to serial signal converting module 2 via at least one data wire, address wire, or control signal wire.

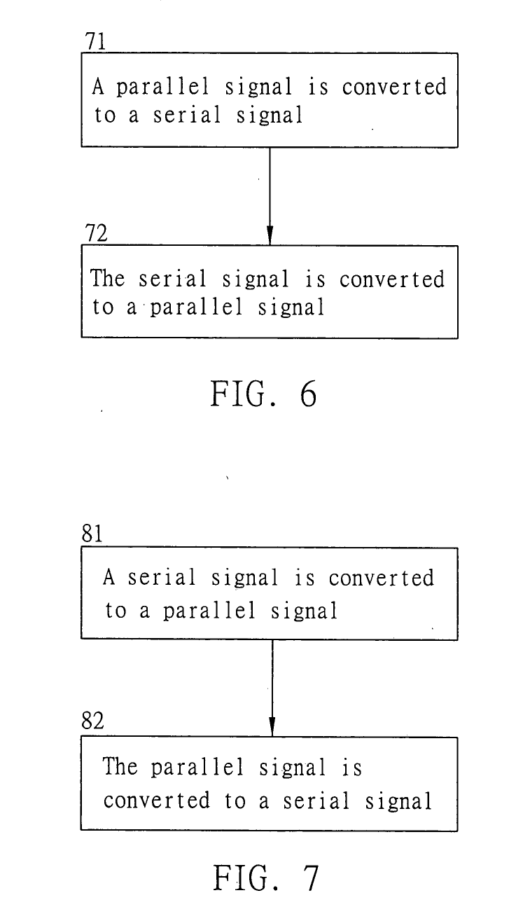

FIG. 6 is a flowchart showing a further set of procedural steps of the data transmission method applicable to the bus architecture shown in FIG. 1. In this embodiment, the bus architecture 1 serves to convert a parallel signal to a serial signal and convert a serial signal to a parallel signal.

Referring to FIG. 6, first in Step 71, a parallel signal of at least one data wire, address wire, or control signal wire is inputted to the parallel signal input terminal 21 of the parallel to serial signal converting module 2, and the parallel to serial signal converting module 2 convert the inputted parallel signal to a serial signal. Then, the serial signal output terminal 22 outputs the converted serial signal to the serial signal input terminal 31 of the serial to parallel signal converting module 3 via a data wire, address wire, or control signal wire. The inputted parallel signal of at least one data wire, address wire, or control signal wire to the parallel to serial signal converting module 2 can be obtained from the functioning components of the information system or from the parallel signal output terminal 32 of the serial to parallel signal converting module 3. Then it proceeds to Step 72.

In Step 72, the serial signal of a single data wire, address wire, or control signal wire is inputted to the serial signal input terminal 31 of the serial to parallel signal converting module 3. The serial signal is obtained from the serial signal output terminal 22 of the parallel to serial signal converting module 2. Subsequently, the serial to parallel signal converting module 3 converts the inputted serial signal to a parallel signal. The parallel signal output terminal 32 then outputs the converted parallel signal to the functioning components of the information system or to the parallel signal input terminal 21 of the parallel to serial signal converting module 2 via at least one data wire, address wire, or control signal wire.

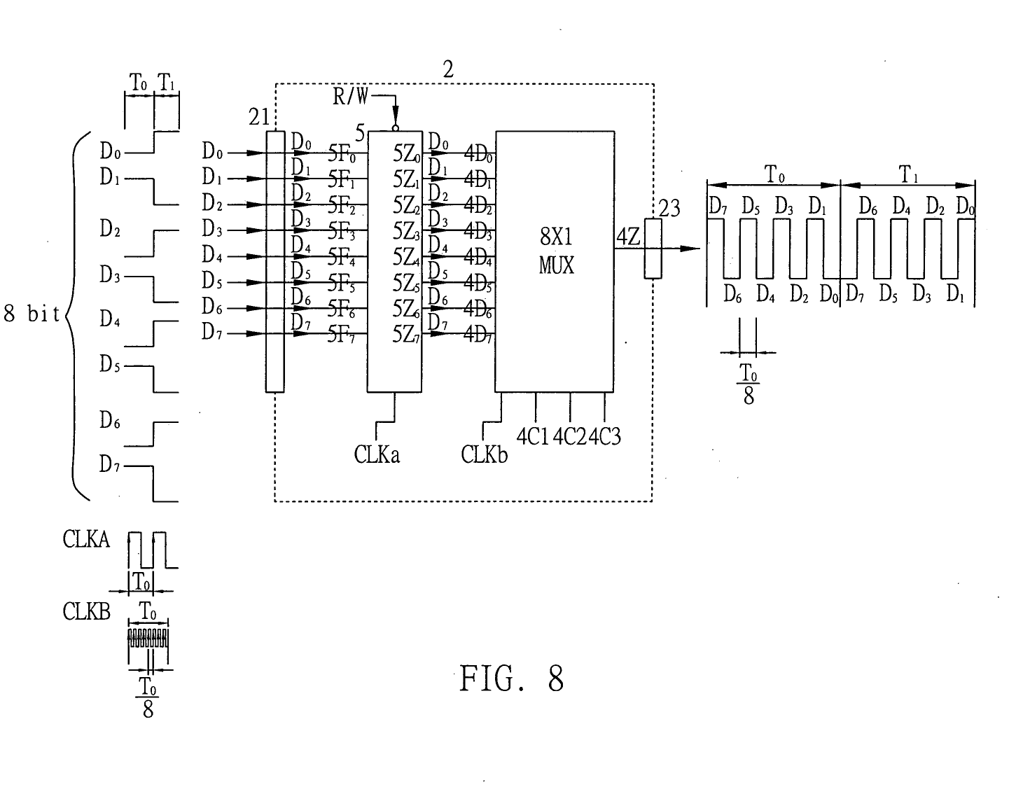

FIG. 7 is a flowchart showing a further set of procedural steps of the data transmission method applicable to the bus architecture 1 shown in FIG. 1. In this embodiment, the bus architecture 1 serves to perform conversion between a parallel signal and a serial signal.

Referring to FIG. 7, first in Step 81, a serial signal of a single data wire, address wire, or control signal wire is inputted to the serial signal input terminal 31 of the serial to parallel signal converting module 3, and the serial to parallel signal converting module 3 converts the inputted serial signal to a parallel signal. Then, the parallel signal output terminal 32 outputs the converted parallel signal to the parallel signal input terminal 21 of the parallel to serial signal converting module 2 via at least one data wire, address wire, or control signal wire. The inputted serial signal of a single data wire, address wire, or control signal wire to the serial to parallel signal converting module 3 can be obtained from the functioning components of the information system or from the serial signal output terminal 22 of the parallel to serial signal converting module 2. Then it proceeds to Step 82.

In Step 82, the parallel signal of at least one data wire, address wire, or control signal wire is inputted to the parallel signal input terminal 21 of the parallel to serial signal converting module 2. The parallel signal is obtained from the parallel signal output terminal 32 of the serial to parallel signal converting module 3. Subsequently, the parallel to serial signal converting module 2 converts the inputted parallel signal to a serial signal. The serial signal output terminal 22 outputs the converted serial signal to the functioning components of the information system or to the serial signal input terminal 31 of the serial to parallel signal converting module 3 via a data wire, address wire, or control signal wire.

FIG. 8 is a block diagram showing a basic structure of the parallel to serial signal converting module 2 of the bus architecture 1 shown in FIG. 1 according to a preferred embodiment of the present invention. In this embodiment, an input signal 44 is of an 8-bit data type that can be parallel data, a parallel address, or a parallel control signal. Referring to FIG. 8, the parallel to serial signal converting module 2 may comprise a multiplexer 4 and a locking data circuit 5. The multiplexer 4 can be of an 8 to 1 MUX type. The parallel signal input terminal 21 of the parallel to serial signal converting module 2 comprises input terminals 5F0-5F7 of the locking data circuit 5. Output terminals 5Z0-5Z7 of the locking data circuit 5 respectively correspond to and are connected to input terminals 4D0-4D7 of the multiplexer 4. The serial signal output terminal 22 of the parallel to serial signal converting module 2 comprises an output terminal 4Z of the multiplexer 4. The multiplexer 4 further comprises three optional control lines 4C1-4C3, such that control input signals of the control lines 4C1-4C3 are used to determine inputted data of which one of the input terminals 4D0-4D7 to be outputted via the output terminal 4Z. The locking data circuit 5 can determine execution of data read-in/data read-out via a R/W terminal. When data D0-D7 are inputted via the input terminals 5F0-5F7, the locking data circuit 5 can perform a function of locking data and locks the data of the output terminals 5Z0-5Z7 respectively as D0-D7. The output terminals 5Z0-5Z7 of the locking data circuit 5, respectively, correspond to and are connected to the input terminals 4D0-4D7 of the multiplexer 4. As shown in FIG. 8, cycle time of a work cycle CLKA of the locking data circuit 5 is T0, and cycle time of a work cycle CLKB of the multiplexer 4 is T0/8. That is, the cycle time of CLKA is 8 times of that of CLKB.

As the data, address, or control signal of the parallel signal is of the 8-bit type, the input signal 44 (parallel data or parallel address data) comprises D0-D7 of the 8-bit data type. Thus, the 8-bit data D0-D7 are respectively and correspondingly inputted to the input terminals 4D0-4D7 of the multiplexer 4, as shown in FIG. 8, wherein the inputted 8-bit data may be data, addresses, or control signals. During the operation of the multiplexer 4, the inputted data of the input terminals 4D0-4D7, such as data, addresses, or control signals, are successively outputted via the output terminal 4Z in accordance with the control input signals of the optional control lines 4C1-4C3. For example, first, in the case of a control input signal [111], datum D7 is outputted via the output terminal 4Z of the multiplexer 4. Subsequently, in the case of a control input signal [110], datum D6 is outputted via the output terminal 4Z of the multiplexer 4. Then, datum D5 is outputted via the output terminal 4Z of the multiplexer 4 in the case of a control input signal [101]. The rest of the data D0-D7 may be deduced by analogy. Finally, datum D0 is outputted via the output terminal 4Z of the multiplexer 4 in the case of a control input signal [000]. Thus, serial data 55 are outputted via the output terminal 4Z, as shown in FIG. 8, wherein cycle time of the serial data 55 is T0, and the serial data 55 comprise the data D0-D7. In this embodiment, the parallel data are of the 8-bit type; however, it should be understood that parallel data of a 4-bit type, 16-bit type, 32-bit type and 64-bit type can also be applicable and deduced similarly, thereby not further to be described.

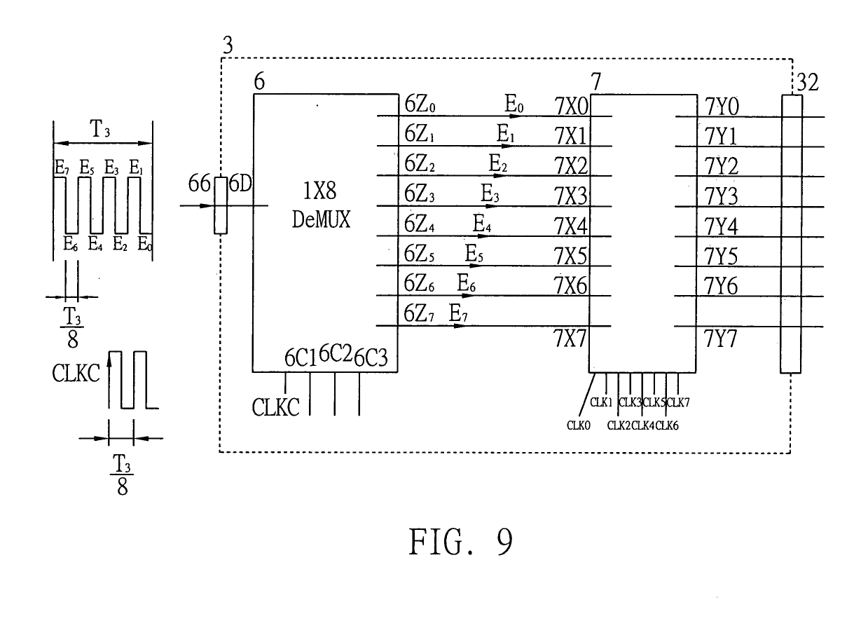

FIG. 9 is a block diagram showing a basic structure of the serial to parallel signal converting module 3 of the bus architecture 1 shown in FIG. 1 according to a preferred embodiment of the present invention. In this embodiment, an input signal 66 is of a serial 8-bit data type and comprises data signals E0-E7, wherein the serial data type may be serial data, serial addresses, or serial control signals. As shown in FIG. 9, the serial to parallel signal converting module 3 comprises a demultiplexer 6 and a digital circuit 7. The demultiplexer 6 can be of a 1×8 DeMUX type, and a work cycle of the demultiplexer 6 is CLKC. The serial signal input terminal 31 of the serial to parallel signal converting module 3 comprises an input terminal 6D of the demultiplexer 6. The parallel signal output terminal 32 of the serial to parallel signal converting module 3 comprises output terminals 7Y0-7Y7 of the digital circuit 7. The demultiplexer 6 further comprises three optional control lines 6C1-6C3, such that input signals of the control lines 6C1-6C3 are used to determine which one of output terminals 6Z0-6Z7 of the demultiplexer 6 to output inputted data of the input terminal 6D. The output terminals 6Z0-6Z7 of the demultiplexer 6 respectively correspond to and are connected to input terminals 7X0-7X7 of the digital circuit 7.

As the serial input signal 66 is of the serial data type, and the serial input signal 66 (serial data, serial addresses, or serial control signals) comprises the signals E0-E7, the output terminals 6Z0-6Z7 of the demultiplexer 6, respectively, and correspondingly output the data E0-E7. Cycle time of the serial input signal 66 is T3, and cycle time of a work cycle CLKC of the demultiplexer 6 is T3/8. Input work cycles of the digital circuit 7 are respectively CLK1 to CLK7. However, cycle time of CLK1 or CLK2-CLK7 is respectively T4 that is equal to T3. Thus, the cycle time of CLK1-CLK7, respectively, is 8 times of that of CLKC.

During the operation of the demultiplexer 6, the data E0-E7 inputted via the input terminal 6D are successively outputted via the output terminals 6Z0-6Z7 in accordance with control input signals of the optional control lines 6C1-6C3. For example, first, in the case of a control input signal [000], datum E0 is outputted via the output terminal 6Z0 using the demultiplexer 6. Subsequently, in the case of a control input signal [001], datum E1 is outputted via the output terminal 6Z1 of the demultiplexer 6. Then, datum E2 is outputted via the output terminal 6Z2 of the demultiplexer 6 in the case of a control input signal [010]. The rest of the data E0-E7 is deduced by analogy. Finally, datum E7 is outputted via the output terminal 6Z7 of the demultiplexer 6 in the case of a control input signal [111].

The data E0-E7 are not outputted via the output terminals 6Z0-6Z7 of the demultiplexer 6 synchronously. The output terminals 6Z0-6Z7 do not perform synchronous data output. Therefore, the digital circuit 7 is used to synchronize the data E0-E7 to be outputted via the output terminals 6Z0-6Z7.

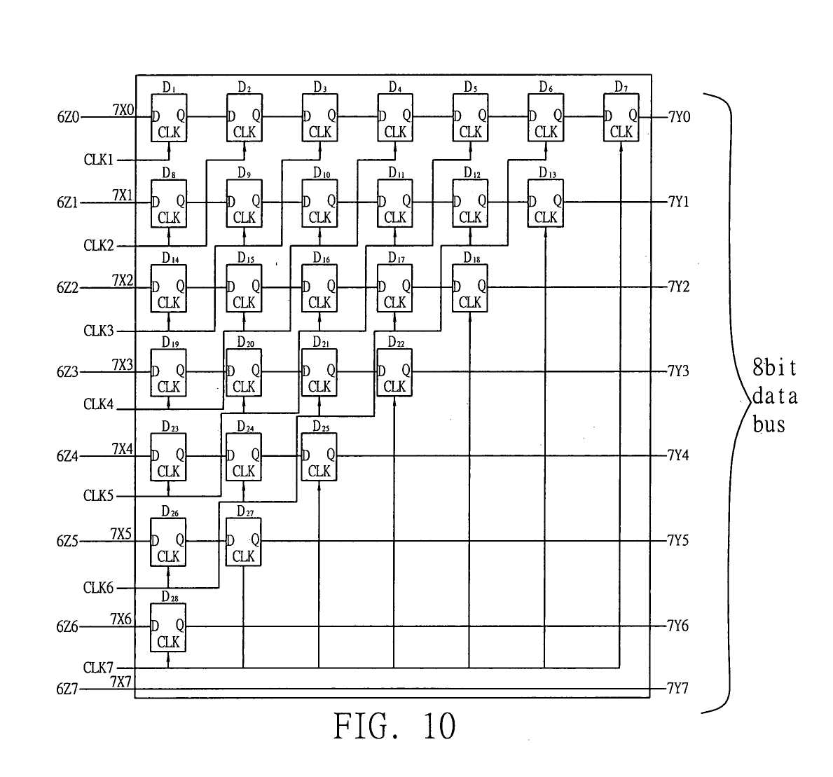

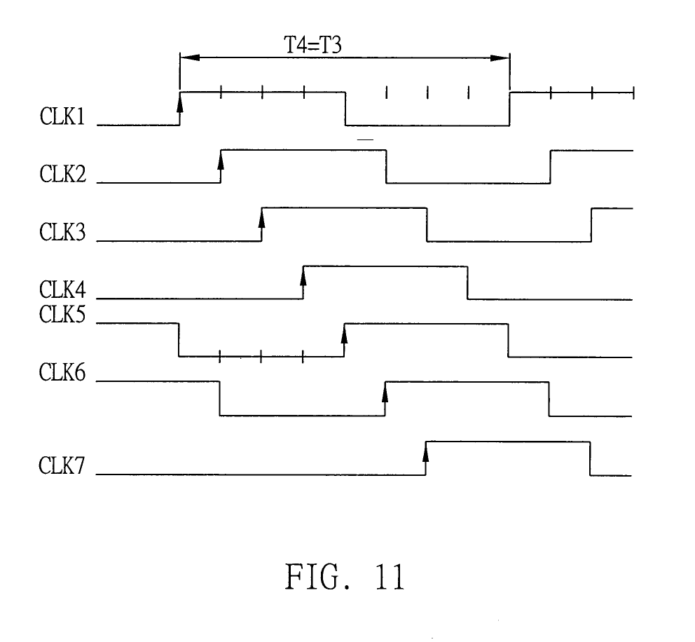

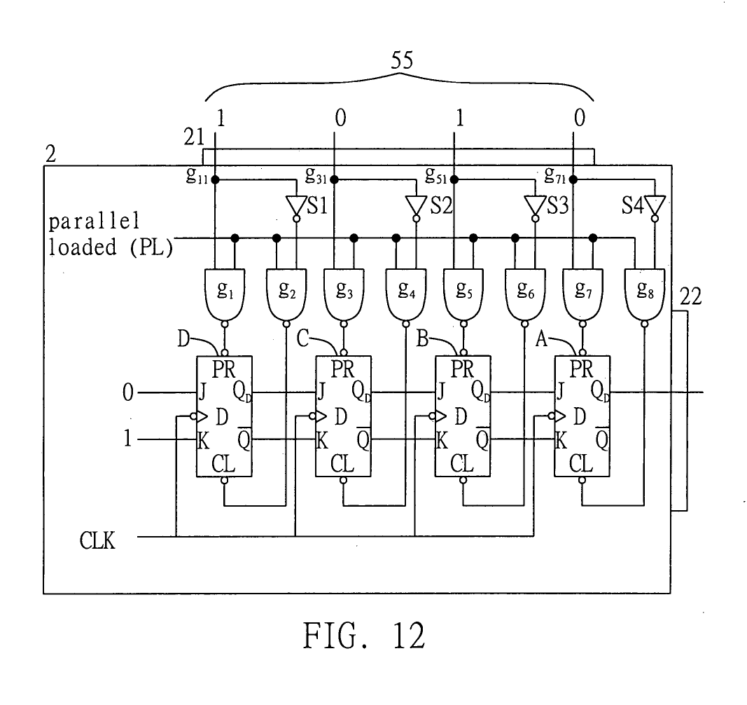

FIG. 10 is a block diagram showing a basic structure of the digital circuit 7 shown in FIG. 9. As shown in FIG. 10, the digital circuit 7 comprises D-flip flops D1-D28. Input terminals 7X0-7X7 of the digital circuit 7 respectively correspond to and are connected to the output terminals 6Z0-6Z7 of the demultiplexer 6. The cycle time of CLK1 to CLK7 respectively is shown in FIG. 11. The cycle time of CLK1 or CLK2-CLK7 is respectively T4 that is equal to T3. Thus, the cycle time of CLK1-CLK7, respectively, is 8 times of that of CLKC. With the provision of the D-flip flops of the digital circuit 7, when the datum E0 is inputted from the output terminal 6Z0 of the demultiplexer 6 to the input terminal 7X0 of the digital circuit 7, the datum E0 is transmitted via the D-flip flop D1, D-flip flop D2, D-flip flop D3, D-flip flop D4, D-flip flop D5, D-flip flop D6. and D-flip flop D7, which respectively have CLK1, CLK2, CLK3, CLK4, CLK5, CLK6 and CLK7 as the input CLK. The inputs of the D-flip flops D1, D2, D3, D4, D5, D6 and D7 are respectively 7X0, the output of D1, the output of D2, the output of D3, the output of D4, the output of D5 and the output of D6; and the output of D7 is the output terminal 7Y0 of the digital circuit 7. The D-flip flops D1 to D7 are used to delay the E0 signal. The operating principles for the D-flip flops D8 to D28 to the signals E1 to E6 can be deduced by analogy, thereby not to be further described. For the signal E7 that is the last signal, it is unnecessary to delay the signal E7. Signals being outputted via output terminals 7Y0-7Y7 of the digital circuit 7 are parallel output signals of the parallel signal output terminal 32 of the serial to parallel signal converting module 3.

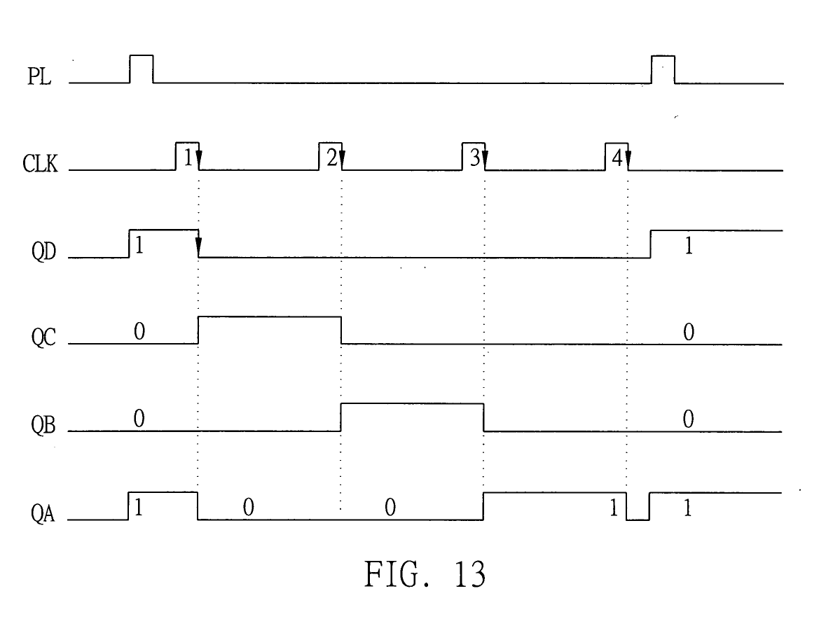

FIG. 12 is a block diagram showing a basic structure of the parallel to serial signal converting module 2 of the bus architecture 1 shown in FIG. 1 according to another preferred embodiment of the present invention. As shown in FIG. 12, an input signal 55 is of a parallel 4-bit data type, wherein the 4-bit data type may be parallel data, parallel addresses or parallel control signals. The parallel to serial signal converting module 2 can comprise JK-flip flops A, B, C and D; NAND gates g1 to g8; and inverted gates S1 to S4. The parallel signal input terminal 21 of the parallel to serial signal converting module 2 comprises input g11 of the NAND gate g1, input g31 of the NAND gate g3, input g51 of the NAND gate g5, and input g71 of the NAND gate g7. Timing of the JK-flip flops A, B, C and D is respectively the same CLK. Referring to FIG. 13, which shows wave alterations of CLK, parallel loaded (PL) signal, output QA of the JK-flip flop A, output QB of the JK-flip flop B, output QC of the JK-flip flop C, and output QD of the JK-flip flop D.

An output terminal Q of the JK-flip flop D is an input terminal J of the JK-flip flop C, and a reverse output terminal Q of the JK-flip flop D is an input terminal K of the JK-flip flop C. An output terminal Q of the JK-flip flop C is an input terminal J of the JK-flip flop B, and a reverse output terminal Q of the JK-flip flop C is an input terminal K of the JK-flip flop B. An output terminal Q of the JK-flip flop B is an input terminal J of the JK-flip flop A, and a reverse output terminal Q of the JK-flip flop B is an input terminal K of the JK-flip flop A. An output terminal Q of the JK-flip flop A is the serial signal output terminal 22 of the parallel to serial signal converting module 2. When a pulse “1→0” is inputted to a clear line (CL) of each of the JK-flip flops A, B, C and D, a shift register would be cleared. When a pulse “1→0” is inputted to a preset (PR) line of each of the JK-flip flops A, B, C and D, the output of the shift register would be preset as 1.

When the parallel loaded (PL) signal is “0”, output values of the gates g1-g8 are all “1” since the parallel loaded (PL) signal is an input terminal of the NAND gates g1 to g8. When the parallel loaded (PL) signal becomes “0→1” and the input signal 55 is a parallel signal [1010], since PL=“1” and g11=“1”, g31=“0”, g51=“1”, and g71=“0”, output values of the gates g1, g4, g6 and g7 become “1→0” and output values of the gates g2, g3, g5 and g8 remain as “1”. The JK-flip flops A and D execute a preset action as output values of the gates g1 and g7 become “1→0”, such that output Q values of the JK-flip flops A and D are set as “1”. The JK-flip flops B and C execute a clear action as output values of the gates g4 and g6 become “1→0”, such that output Q values of the JK-flip flops B and C are set as “0”. Therefore, the JK-flip flop A has the output QA=“1”; the JK-flip flop B has the output QB=“0”; the JK-flip flop C has the output QC=“0”; and the JK-flip flop D has the output QD=“1”.

Moreover, when the parallel loaded (PL) signal is “0”, the preset action and the clear action cannot be performed. The JK-flip flops A, B, C and D are able to perform a function of the shift register along with the “1→0” of the CLK being inputted. After the first clock cycle, the output of the JK-flip flop A becomes “1→0”. Then, after the second clock cycle, the output of the JK-flip flop A becomes “0→0”. Finally, after the third clock cycle, the output of the JK-flip flop A becomes “0→1”. Thus, the action of outputting the serial signals “1”, “0”, “0”, “1” has been completed via the output terminal QA of the JK-flip flop A.

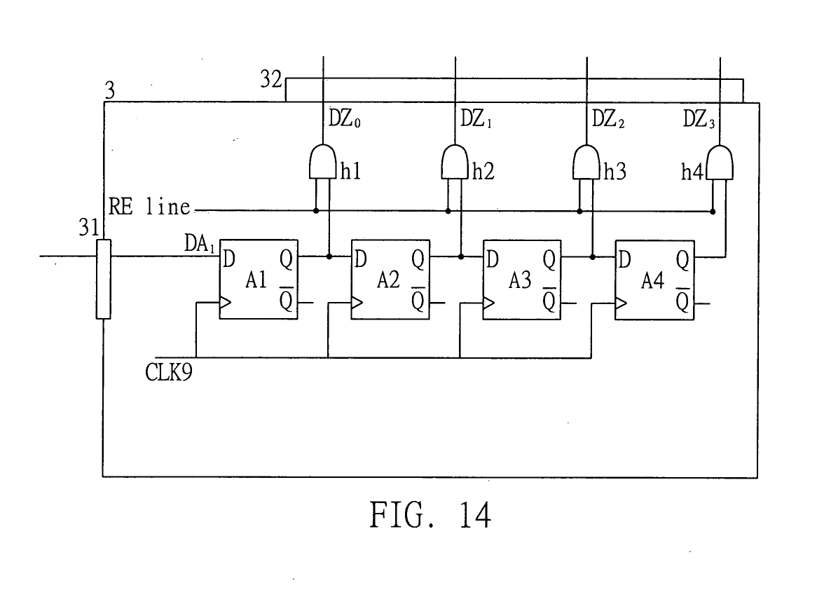

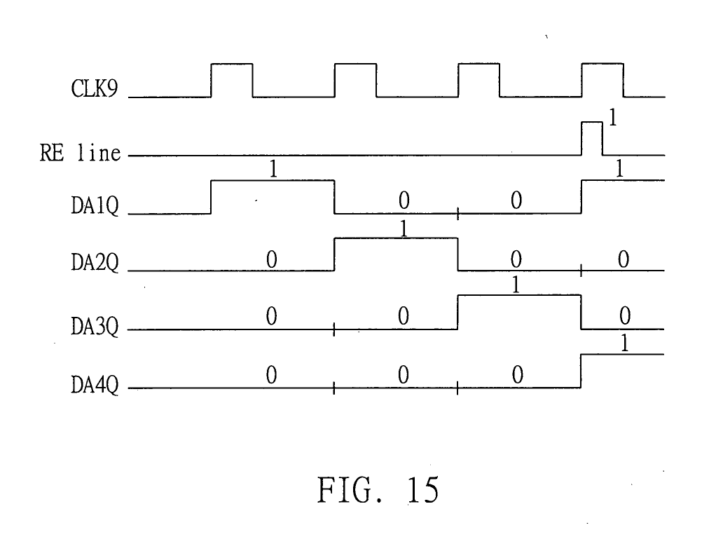

FIG. 14 is a block diagram showing a basic structure of the serial to parallel signal converting module 3 of the bus architecture 1 shown in FIG. 1 according to another preferred embodiment of the present invention. In this embodiment, an input signal 77 is of a serial 4-bit data type, wherein the serial data type can be serial data, serial addresses or serial control signals. As shown in FIG. 14, the serial to parallel signal converting module 3 can comprise D-flip flops A1, A2, A3 and A4, and AND gates h1 to h4. The serial signal input terminal 31 of the serial to parallel signal converting module 3 is an input terminal DA1 of the D-flip flop A1. The parallel signal output terminal 32 comprises output terminals DZ0-DZ3 of the gates h1 to h4. An output terminal DA1Q of the D-flip flop A1 is an input of the gate h1 and is connected to an input terminal DA2 of the D-flip flop A2. An output terminal DA2Q of the D-flip flop A2 is an input of the gate h2 and is connected to an input terminal DA3 of the D-flip flop A3. An output terminal DA3Q of the D-flip flop A3 is an input of the gate h3 and is connected to an input terminal DA4 of the D-flip flop A4. An output terminal DA4Q of the D-flip flop A4 is an input of the gate h4. Timing of the D-flip flops A1, A2, A3 and A4 is respectively the same CLK9.

Four clock pulses are required to load the 4-bit serial input signal 77 into the register (i.e., the D-flip flops A1, A2, A3 and A4). After the fourth pulse, a valid 4-bit datum is remained in the register. When this 4-bit datum is outputted, a RE (read enable) line needs to be at a high potential status, and the AND gates h1 to h4 are capable of outputting all of the data stored in the shift register once by means of four parallel output terminals DZ0, DZ1, DZ2 and DZ3. In other words, the signal data of the output terminals DA1Q-DA4Q of the D-flip flops A1-A4 can be synchronously outputted via DZ0-DZ3. The four extra clock pulses required for the serial output are not necessary here but should be needed for re-cycling.

FIG. 15 is a schematic diagram showing timing of the serial to parallel signal converting module 3 shown in FIG. 14. As shown in FIG. 15, the input signal 77, which has 4-bit serial data, is “1”, “0”, “0”, “1”. After the first clock pulse of the CLK9, an output signal of the output terminal DA1Q of the D-flip flop A1 is “1”. Since the output terminal DA1Q of the D-flip flop A1 is connected to the input terminal DA2 of the D-flip flop A2, this signal “1” serves as input of the input terminal DA2 of the D-flip flop A2. Subsequently, after the second clock pulse of the CLK9, the output signal of the output terminal DA1Q of the D-flip flop A1 becomes “1→0”. As the output terminal DA1Q of the D-flip flop A1 is connected to the input terminal DA2 of the D-flip flop A2, this signal “0” serves as input of the input terminal DA2 of the D-flip flop A2. Also, during the second clock pulse of the CLK9, as the signal of the input terminal DA2 of the D-flip flop A2 is “1”, the signal of the output terminal DA2Q of the D-flip flop A2 would be “1” after the second clock pulse of the CLK9. Since the output terminal DA2Q of the D-flip flop A2 is connected to the input terminal DA3 of the D-flip flop A3, this signal “1” serves as input of the input terminal DA3 of the D-flip flop A3. Similarly, it can be deduced that, after the fourth clock pulse of the CLK9, the signal of the output terminal DA1Q of the D-flip flop A1 is “1”; the signal of the output terminal DA2Q of the D-flip flop A2 is “0”; the signal of the output terminal DA3Q of the D-flip flop A3 is “0”; and the signal of the output terminal DA4Q of the D-flip flop A4 is “1”, wherein the D-flip flops A1-A4 serve as the shift register.

After the fourth clock pulse of the CLK9, the signal of the output terminal DA1Q of the D-flip flop A1 is “1”; the signal of the output terminal DA2Q of the D-flip flop A2 is “0”; and the signal of the output terminal DA3Q of the D-flip flop A3 is “0”. After inputting a pulse into the RE line, the signals “1”, “0”, “0” and “1” are synchronously outputted via the output terminals DZ0, DZ1, DZ2 and DZ3 of the gates h1-h4 respectively. In other words, the outputted signal data of the output terminals DA1Q-DA4Q of the D-flip flops A1-A4 are synchronously outputted via the output terminals DZ0-DZ3.

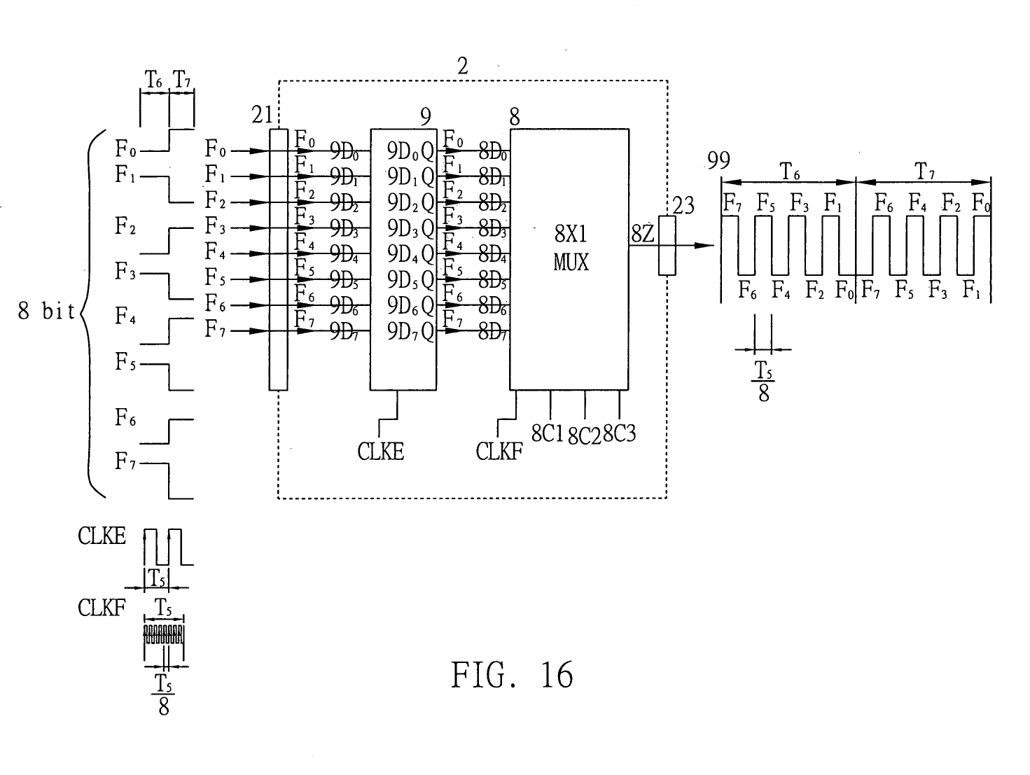

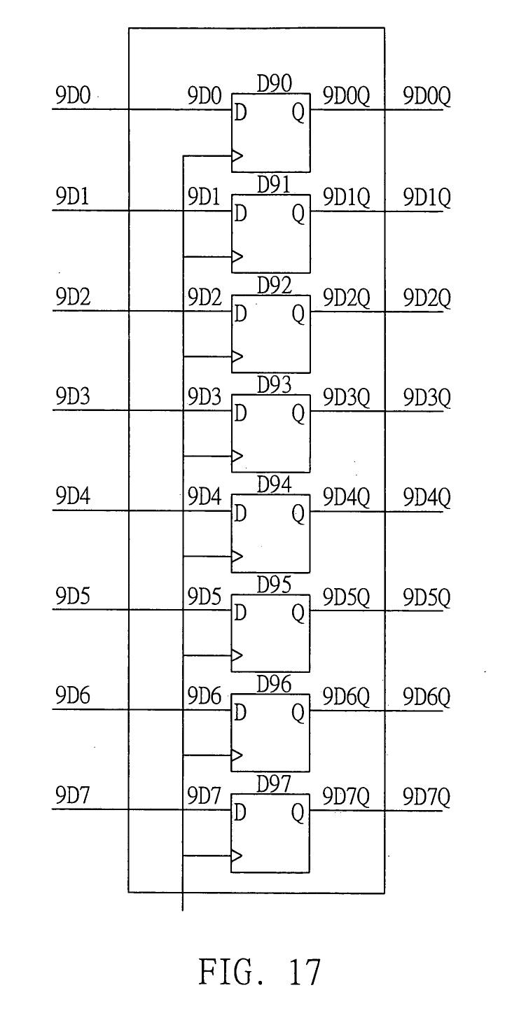

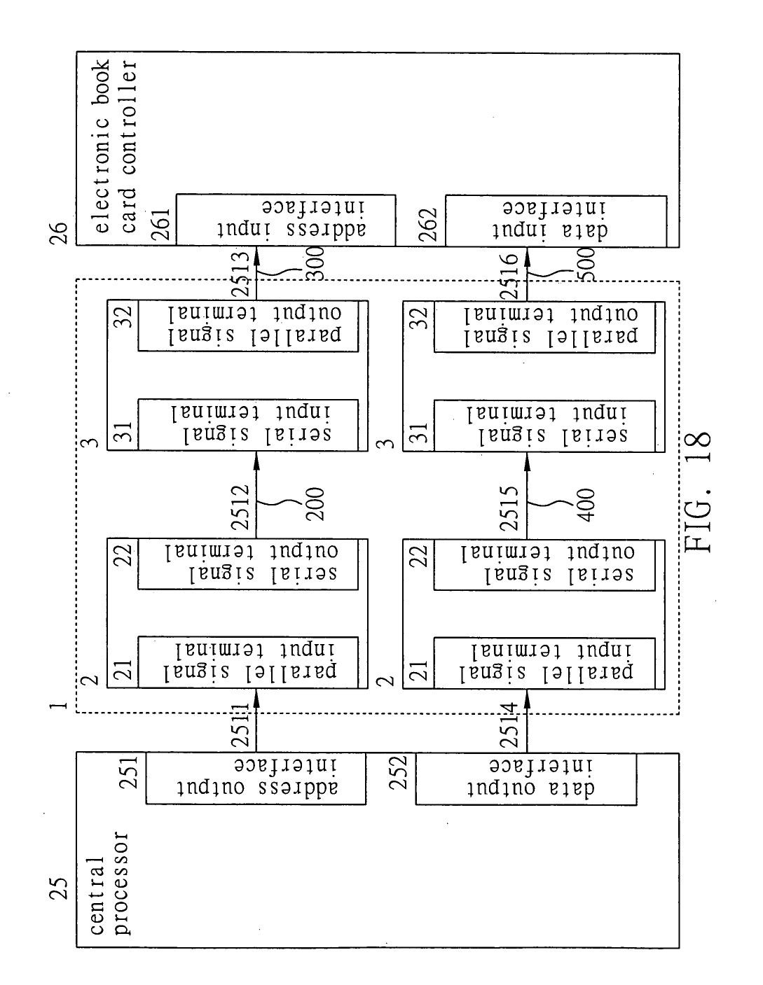

FIG. 16 is a block diagram showing a basic structure of the parallel to serial signal converting module 2 of the bus architecture 1 shown in FIG. 1 according to a further preferred embodiment of the present invention. In this embodiment, an input signal 88 is of an 8-bit data type, wherein the 8-bit data type can be parallel data, parallel addresses or parallel control signals. As shown in FIG. 16, the parallel to serial signal converting module 2 can comprise a multiplexer 8 and a digital circuit 9. The multiplexer 8 can be of an 8 to 1 MUX type. The parallel signal input terminal 21 of the parallel to serial signal converting module 2 comprises input terminals 9D0-9D7 of the digital circuit 9. Output terminals 9D0Q-9D7Q of the digital circuit 9 respectively correspond to and are connected to input terminals 8D0-8D7 of the multiplexer 8. The serial signal output terminal 22 of the parallel to serial signal converting module 2 comprises an output terminal 8Z of the multiplexer 8. The multiplexer 8 further comprises three optional control lines 8C1-8C3, such that control input signals of the control lines 8C1-8C3 are used to determine inputted data of which one of the input terminals 8D0-8D7 to be outputted via the output terminal 8Z. Also, since the output terminals 9D0Q-9D7Q of the digital circuit 9 are respectively and correspondingly connected to the input terminals 8D0-8D7 of the multiplexer 8, data F0-F7 of the output terminals 9D0Q-9D7Q are respectively inputted to the input terminals 8D0-8D7 of the multiplexer 8. The digital circuit 9 is described later with reference to FIG. 17.

As shown in FIG. 16, cycle time of a work cycle CLKE of the digital circuit 9 is T5, and cycle time of a work cycle CLKF of the multiplexer 8 is T5/8. Therefore, the cycle time of the CLKE is 8 times of that of the CLKF. As the data, address, or control signal of the parallel data type is of the 8-bit type, the input signal 88 (parallel data, parallel address, or parallel control signal) of the 8-bit data type comprises the data F0-F7. Thus, the 8-bit data F0-F7 are respectively and correspondingly inputted via the input terminals 8D0-8D7 of the multiplexer 8, wherein the inputted 8-bit data can be data, addresses or control signals. During the operation of the multiplexer 8, the data inputted via the input terminals 8D0-8D7, such as data, addresses, or control signals, are successively outputted via the output terminal 8Z in accordance with control input signals of the optional control lines 8C1-8C3. For example, first, in the case of a control input signal [111], datum F7 is outputted via the output terminal 8Z of the multiplexer 8. Subsequently, in the case of a control input signal [110], datum F6 is outputted via the output terminal 8Z of the multiplexer 8. Then, datum F5 is outputted via the output terminal 8Z of the multiplexer 8 in the case of a control input signal [101]. The rest of the data F0-F7 can be deduced by analogy. Finally, datum F0 is outputted via the output terminal 8Z of the multiplexer 8 in the case of a control input signal [000]. Thus, serial data 99 are outputted via the output terminal 8Z, wherein cycle time of the serial data 99 is T5, and the serial data 99 comprises the data F0-F7.

FIG. 17 is a block diagram showing a basic structure of the digital circuit 9 shown in FIG. 16. Referring to FIG. 17, the digital circuit 9 can comprise D-flip flops D91-D97 that respectively have input terminals 9D0-9D7 and output terminals 9D0Q-9D7Q. The parallel signal input terminal 21 of the parallel to serial signal converting module 2 comprises the input terminals 9D0-9D7 of the digital circuit 9. The output terminals 9D0Q-9D7Q of the digital circuit 9 are respectively and correspondingly connected to the input terminals 8D0-8D7 of the multiplexer 8.

The clock pulses of the D-flip flops D91-D97 are all CLKE, and the clock pulse of the multiplexer 8 is CLKF. The cycle time of the work cycle CLKE of the digital circuit 9 is T5, and the cycle time of the work cycle CLKF of the multiplexer 8 is T5/8. Therefore, the cycle time of the CLKE is 8 times of that of the CLKF. When the data F0-F7 are respectively inputted to the D-flip flops D91-D97 via the input terminals 9D0-9D7, and the clock pulse of the CKLE becomes “0→1”, the D-flip flops D91-D97 convert the inputted data F0-F7 to output signals that are respectively outputted via the output terminals 9D0Q-9D7Q. Time of the data F0-F7 registered on the output terminals 9D0Q-9D7Q is the cycle time T5 of the CLKE. In other words, within one cycle time T5 of the clock pulse CLKE, the output signals on the output terminals 9D0Q-9D7Q of the D-flip flops D91-D97 remain unchanged. Such unchanged characteristic of the output signals on the output terminals 9D0Q-9D7Q within the cycle time T5 is similar to that of the data F0-F7 registered on the output terminals 9D0Q-9D7Q of the D-flip flops D91-D97. Within this cycle time T5, the data F0-F7 are available for the multiplexer 8. As the cycle time T5 of the CLKE is 8 times of that of CLKF, the multiplexer 8 is able to perform 8 work cycles within one cycle time T5. In other words, the multiplexer 8 can operate 8 times to successively and respectively output the data F0-F7 via the output terminal 8Z thereof.

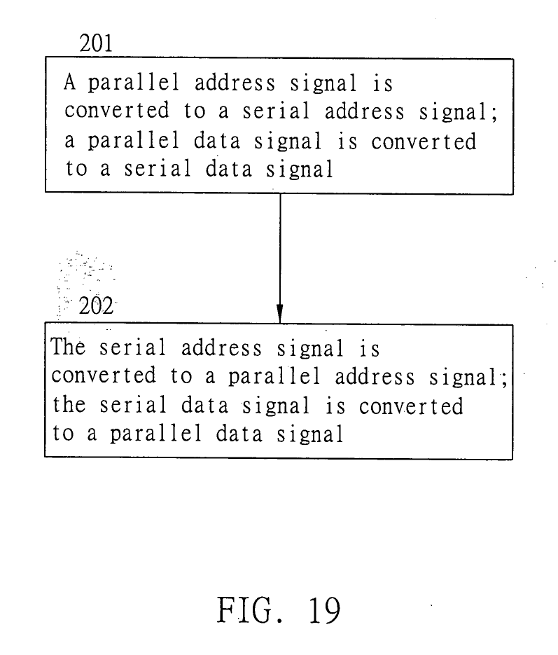

FIG. 18 is a schematic diagram showing application of the bus architecture according to a preferred embodiment of the present invention. Referring to FIG. 18, the bus architecture 1 is applied between a central processor 25 and an electronic book card controller 26.

The parallel signal input terminal 21 of one parallel to serial signal converting module 2 of the bus architecture 1 is connected to an address output interface 251 of the central processor 25, and receives a parallel address signal 2511 from the address output interface 251 of the central processor 25. The parallel signal output terminal 32 of one serial to parallel signal converting module 3 is connected to an address input interface 261 of the electronic book card controller 26, and transmits a parallel signal 2513 to the address input interface 261 of the electronic book card controller 26.

The parallel signal input terminal 21 of the parallel to serial signal converting module 2 is inputted with the parallel address signal 2511 from the address output interface 251 of the central processor 25. The parallel to serial signal converting module 2 converts the parallel address signal 2511 to a serial signal 2512 that is subsequently outputted by the serial signal output terminal 22 thereof. The outputted serial signal 2512 can be transmitted to the serial signal input terminal 31 of the serial to parallel signal converting module 3 via an address wire 200.

When the serial signal input terminal 31 of the serial to parallel signal converting module 3 receives the serial signal 2512 from the single address wire 200, the serial to parallel signal converting module 3 converts the inputted serial signal 2512 to the parallel signal 2513 that is subsequently outputted by the parallel signal output terminal 32. The outputted parallel signal 2513 can be transmitted to the address input interface 261 of the electronic book card controller 26 via at least one address wire 300.

The parallel signal input terminal 21 of the other parallel to serial signal converting module 2 of the bus architecture 1 is connected to a data output interface 252 of the central processor 25, and receives a parallel data signal 2514 from the data output interface 252 of the central processor 25. The parallel signal output terminal 32 of the other serial to parallel signal converting module 3 of the bus architecture 1 is connected to a data input interface 262 of the electronic book card controller 26, and transmits a parallel signal 2516 to the data input interface 262 of the electronic book card controller 26.

When the parallel signal input terminal 21 of this parallel to serial signal converting module 2 is inputted with the parallel data signal 2514 from the data output interface 252 of the central processor 25, the parallel to serial signal converting module 2 converts the parallel data signal 2514 to a serial signal 2515 that is subsequently outputted by the serial signal output terminal 22 thereof. The outputted serial signal 2515 is transmitted to the serial signal input terminal 31 of this serial to parallel signal converting module 3 via a data wire 400.

When the serial signal input terminal 31 of this serial to parallel signal converting module 3 receives the serial signal 2515 from the single data wire 400, the serial to parallel signal converting module 3 converts the inputted serial signal 2515 into the parallel signal 2516 that is subsequently outputted by the parallel signal output terminal 32. The outputted parallel signal 2516 can be transmitted to the data input interface 262 of the electronic book card controller 26 via at least one data wire 500.

The application of the parallel to serial signal converting module 2 can be performed by using the circuitry shown in FIG. 8, FIG. 12 or FIG. 16. The application of the serial to parallel signal converting module 3 can be performed by using the circuitry shown in FIG. 9 or FIG. 14.

In this embodiment, the parallel to serial signal converting module 2 and the serial to parallel signal converting module 3 of the bus architecture 1 are made as external circuits being combined with the central processor 25 and the electronic book card controller 26. However, it should be understood that the parallel to serial signal converting module 2 of the bus architecture 1 can be internally constructed in the central processor 25 during fabrication. Similarly, the serial to parallel signal converting module 3 can be internally constructed in the electronic book card controller 26 during fabrication. The way of internally constructing such modules is similar to the way of arranging the parallel to serial signal converting module 2 and the serial to parallel signal converting module 3 as the externals circuit, thereby not to be further described.

FIG. 19 is a flowchart showing a set of procedural steps of the data transmission method applicable to the bus architecture 1 shown in FIG. 18. Referring to FIG. 19, first in Step 201, the parallel signal input terminal 21 of one parallel to serial signal converting module 2 is inputted with the parallel address signal 2511 from the address output interface 251 of the central processor 25. Then, the parallel to serial signal converting module 2 converts the parallel address signal 2511 to a serial signal 2512 that is subsequently outputted by the serial signal output terminal 22 thereof. The outputted serial signal 2512 can be transmitted to the serial signal input terminal 31 of one serial to parallel signal converting module 3 via an address wire 200. Furthermore, the parallel signal input terminal 21 of the other parallel to serial signal converting module 2 is inputted with the parallel data signal 2514 from the data output interface 252 of the central processor 25. Then, this parallel to serial signal converting module 2 converts the parallel data signal 2514 to a serial signal 2515 that is subsequently outputted by the serial signal output terminal 22 thereof. The outputted serial signal 2515 can be transmitted to the serial signal input terminal 31 of the other serial to parallel signal converting module 3 via a data wire 400. Then it proceeds to Step 202.

In Step 202, when the serial signal input terminal 31 of one serial to parallel signal converting module 3 receives the serial signal 2512 from the single address wire 200, the serial to parallel signal converting module 3 converts the inputted serial signal 2512 to the parallel signal 2513 that is subsequently outputted by the parallel signal output terminal 32 thereof. The outputted parallel signal 2513 can be transmitted to the address input interface 261 of the electronic book card controller 26 via at least one address wire 300. Furthermore, when the serial signal input terminal 31 of the other serial to parallel signal converting module 3 receives the serial signal 2515 from the single data wire 400, the serial to parallel signal converting module 3 converts the inputted serial signal 2515 to the parallel signal 2516 that is subsequently outputted by the parallel signal output terminal 32 thereof. The outputted parallel signal 2516 can be transmitted to the data input interface 262 of the electronic book card controller 26 via at least one data wire 500.

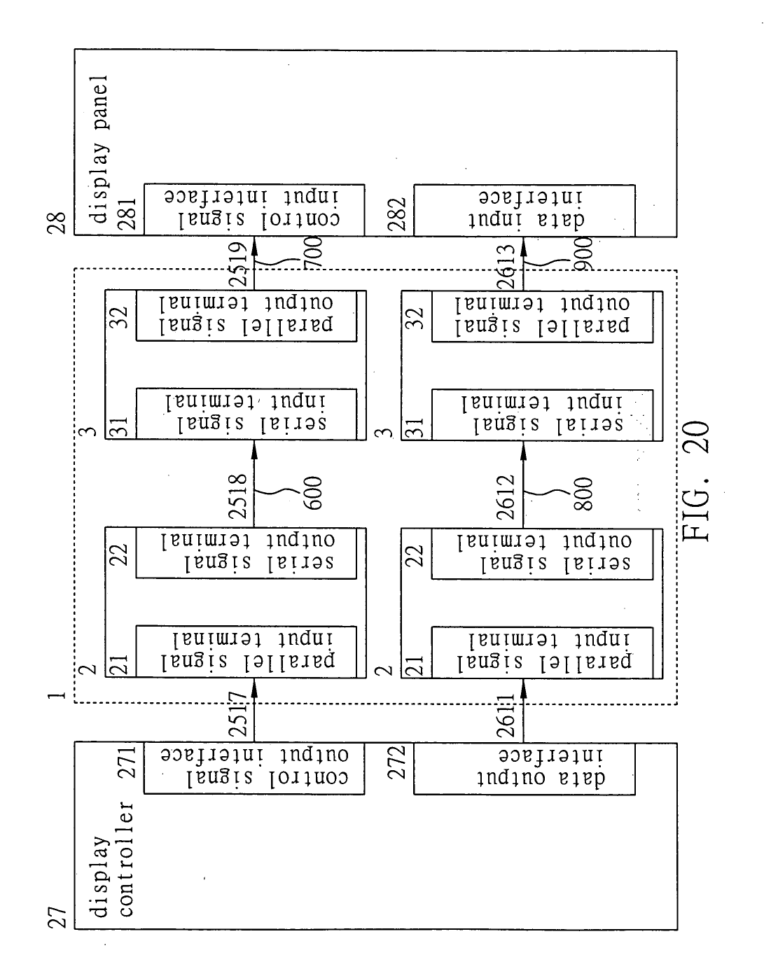

FIG. 20 is a schematic diagram showing application of the bus architecture according to another preferred embodiment of the present invention. Referring to FIG. 20, the bus architecture 1 is applied between a display controller 27 and a display panel 28.

The parallel signal input terminal 21 of one parallel to serial signal converting module 2 of the bus architecture 1 is connected to a control signal output interface 271 of the display controller 27, and receives a parallel control signal 2517 from the control signal output interface 271 of the display controller 27. The parallel signal output terminal 32 of one serial to parallel signal converting module 3 is connected to a control signal input interface 281 of the display panel 28, and transmits a parallel signal 2519 to the control signal input interface 281 of the display panel 28.

When the parallel signal input terminal 21 of this parallel to serial signal converting module 2 is inputted with the parallel control signal 2517 from the control signal output interface 271 of the display controller 27, the parallel to serial signal converting module 2 converts the parallel control signal 2517 to a serial signal 2518 that is subsequently outputted by the serial signal output terminal 22 thereof. The outputted serial signal 2518 can be transmitted to the serial signal input terminal 31 of the serial to parallel signal converting module 3 via a control signal wire 600.

When the serial signal input terminal 31 of the serial to parallel signal converting module 3 receives the serial signal 2518 from the single control signal wire 600, the serial to parallel signal converting module 3 converts the inputted serial signal 2518 to the parallel signal 2519 that is subsequently outputted by the parallel signal output terminal 32 thereof. The outputted parallel signal 2519 can be transmitted to the control signal input interface 281 of the display panel 28 via at least one control signal wire 700.

The parallel signal input terminal 21 of the other parallel to serial signal converting module 2 of the bus architecture 1 is connected to a data output interface 273 of the display controller 27, and receives a parallel data signal 2611 from the data output interface 273 of the display controller 27. The parallel signal output terminal 32 of the other serial to parallel signal converting module 3 is connected to a data input interface 282 of the display panel 28, and transmits a parallel signal 2613 to the data input interface 282 of the display panel 28.

When the parallel signal input terminal 21 of this parallel to serial signal converting module 2 is inputted with the parallel data signal 2611 from the data output interface 273 of the display controller 27, the parallel to serial signal converting module 2 converts the parallel data signal 2611 to a serial signal 2612 that is subsequently outputted by the serial signal output terminal 22 thereof. The outputted serial signal 2612 can be transmitted to the serial signal input terminal 31 of the serial to parallel signal converting module 3 using a data wire 800.

When the serial signal input terminal 31 of the serial to parallel signal converting module 3 receives the serial signal 2612 from the single data wire 800, the serial to parallel signal converting module 3 converts the inputted serial signal 2612 to the parallel signal 2613 that is subsequently outputted by the parallel signal output terminal 32 thereof. The outputted parallel signal 2613 can be transmitted to the data input interface 282 of the display panel 28 via at least one data wire 900.

The application of the parallel to serial signal converting module 2 can be performed by using the circuitry shown in FIG. 8, FIG. 12 or FIG. 16. The application of the serial to parallel signal converting module 3 can be performed by using the circuitry shown in FIG. 9 or FIG. 14.

In this embodiment, the parallel to serial signal converting module 2 and the serial to parallel signal converting module 3 of the bus architecture 1 are made as external circuits being combined with the display controller 27 and the display panel 28. However, it should be understood that the parallel to serial signal converting module 2 of the bus architecture 1 can be internally constructed in the display controller 27 during fabrication. Similarly, the serial to parallel signal converting module 3 can be internally constructed in the display panel 28 during fabrication. The way of internally constructing such modules is similar to the way of arranging the parallel to serial signal converting module 2 and the serial to parallel signal converting module 3 as the externals circuit, thereby not to be further described.

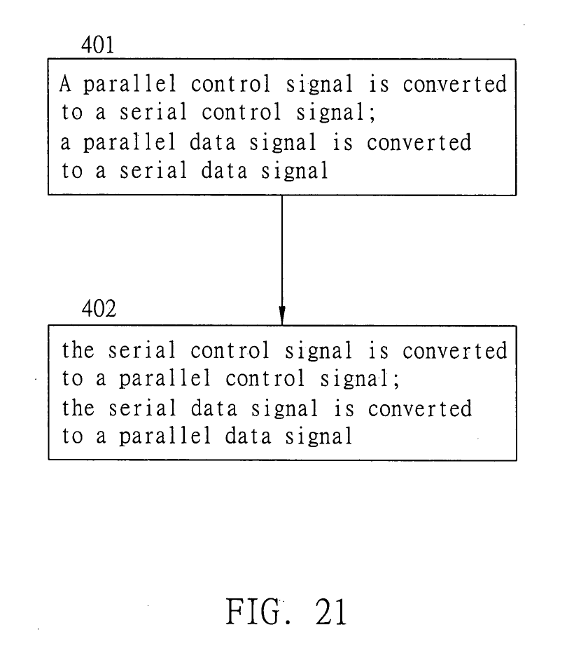

FIG. 21 is a flowchart showing a set of procedural steps of the data transmission method applicable to the bus architecture shown in FIG. 20. Referring to FIG. 21, first in Step 401, the parallel signal input terminal 21 of one parallel to serial signal converting module 2 is inputted with the parallel control signal 2517 from the control signal output interface 271 of the display controller 27. Then, the parallel to serial signal converting module 2 converts the parallel control signal 2517 to a serial signal 2518 that is subsequently outputted by the serial signal output terminal 22 thereof. The outputted serial signal 2518 can be transmitted to the serial signal input terminal 31 of one serial to parallel signal converting module 3 via a control signal wire 600. Furthermore, the parallel signal input terminal 21 of the other parallel to serial signal converting module 2 is inputted with the parallel data signal 2611 from the data output interface 273 of the display controller 27. Then, the parallel to serial signal converting module 2 converts the parallel data signal 2611 to a serial signal 2612 that is subsequently outputted by the serial signal output terminal 22 thereof. The outputted serial signal 2612 can be transmitted to the serial signal input terminal 31 of the other serial to parallel signal converting module 3 via a data wire 800. Then it proceeds to Step 402.

In Step 402, when the serial signal input terminal 31 of one serial to parallel signal converting module 3 receives the serial signal 2518 from the single control signal wire 600, the serial to parallel signal converting module 3 converts the inputted serial signal 2518 to the parallel signal 2519 that is subsequently outputted by the parallel signal output terminal 32 thereof. The outputted parallel signal 2519 can be transmitted to the control signal input interface 281 of the display panel 28 via at least one control signal wire 700. Furthermore, when the serial signal input terminal 31 of the other serial to parallel signal converting module 3 receives the serial signal 2612 from the single data wire 800, the serial to parallel 5 signal converting module 3 converts the inputted serial signal 2612 to the parallel signal 2613 that is subsequently outputted by the parallel signal output terminal 32 thereof. The outputted parallel signal 2613 can be transmitted to the data input interface 282 of the display panel 28 via at least one data wire 900.

Therefore, the bus architecture and the data transmission method thereof proposed in lo the present invention are applicable to a signal transmission environment between units, elements, components and devices of an information system, so as to transmit data, addresses and/or control signals between any two of the units, elements, components and devices of the information system in a serial transmission manner via at least one wire. During the data transmission method, the bus architecture can convert a parallel signal to a serial signal and/or convert a serial signal to a parallel signal, and the sequence of the two conversions being performed or the proceeding of only one or both of the conversions depends on practical requirements. The bus architecture and the data transmission method thereof proposed in the present invention provide the following advantages.
1. The bus architecture and the data transmission method thereof are applicable to a signal transmission environment between units, elements, components, and devices of an information system, so as to transmit data, addresses, and control signals between any two of the units, elements, components, and devices of the information system in a serial transmission manner via at least one wire.
2. The number of leads of a data bus and an address bus that are connected to a processor can be reduced.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

1. A data transmission method of bus architecture, applicable to a signal transmission environment between units, elements, components and devices of an information system, the data transmission method comprising the step of:
converting a parallel signal of at least one wire to a serial signal and outputting the serial signal.

2. The data transmission method of claim 1, further comprising the step of:
converting a serial signal of a wire to a parallel signal and outputting this parallel signal.

3. A data transmission method of bus architecture, applicable to a signal transmission environment between units, elements, components and devices of an information system, the data transmission method comprising the step of:
providing a parallel to serial signal converting module to convert a parallel signal from at least one wire to a serial signal and output the serial signal.

4. The data transmission method of claim 3, further comprising the step of:
providing a serial to parallel signal converting module to convert the serial signal outputted from the parallel to serial signal converting module to a parallel signal and output this parallel signal.

5. A data transmission method of bus architecture, applicable to a signal transmission environment between units, elements, components and devices of an information system, the data transmission method comprising the step of:
providing a parallel to serial signal converting module to convert a parallel signal from at least one wire to a serial signal and output the serial signal, wherein the serial signal is outputted to a serial to parallel signal converting module.

6. The data transmission method of claim 5, further comprising the step of:
converting the serial signal outputted from the parallel to serial signal converting module to a parallel signal and outputting this parallel signal via the serial to parallel signal converting module.

7. The data transmission method of claim 1, wherein the wire is selected from the group consisting of a data wire for transmitting data, an address wire for transmitting addresses, and a control signal wire for transmitting control signals.

8. The data transmission method of claim 2, wherein the wire is selected from. the group consisting of a data wire for transmitting data, an address wire for transmitting addresses, and a control signal wire for transmitting control signals.

9. The data transmission method of claim 3, wherein the wire is selected from the group consisting of a data wire for transmitting data, an address wire for transmitting addresses, a control signal wire for transmitting control signals.

10. A data transmission method of bus architecture, applicable to a signal transmission environment between units, elements, components and devices of an information system, the data transmission method comprising the step of:
providing a parallel to serial signal converting module to convert a parallel data signal and a parallel address signal being inputted from at least one wire to a serial data signal and a serial address signal respectively, and output the serial data signal and the serial address signal.

11. The data transmission method of claim 10, wherein the serial data signal and the serial address signal are outputted to a serial to parallel signal converting module, and the data transmission method further comprises the step of:
converting the serial data signal and the serial address signal obtained from the parallel to serial signal converting module to a parallel data signal and a parallel address signal respectively, and outputting this parallel data signal and this parallel address signal via the serial to parallel signal converting module.

12. A data transmission method of bus architecture, applicable to a signal transmission environment between units, elements, components and devices of an information system, the data transmission method comprising the step of:
providing a parallel to serial signal converting module to convert a parallel data signal and a parallel control signal being inputted from at least one wire to a serial data signal and a serial control signal respectively, and output the serial data signal and the serial control signal.

13. The data transmission method of claim 12, wherein the serial data signal and the serial control signal are outputted to a serial to parallel signal converting module, and the data transmission method further comprises the step of:
converting the serial data signal and the serial control signal obtained from the parallel to serial signal converting module to a parallel data signal and a parallel control signal respectively, and outputting this parallel data signal and this parallel control signal via the serial to parallel signal converting module.

14. The data transmission method of claim 3, wherein the parallel to serial signal converting module comprises a digital circuit and a multiplexer, with the digital circuit comprising at least one flip flop; or the parallel to serial signal converting module comprises a digital circuit comprising at least one flip flop, at least one NAND gate and at least one inverted gate: or the parallel to serial signal converting module comprises a locking data circuit and a multiplexer.

15. The data transmission method of claim 5, wherein the parallel to serial signal converting module comprises a digital circuit and a multiplexer, with the digital circuit comprising at least one flip flop; or the parallel to serial signal converting module comprises a digital circuit comprising at least one flip flop, at least one NAND gate and at least one inverted gate; or the parallel to serial signal converting module comprises a locking data circuit and a multiplexer.

16. The data transmission method of claim 10, wherein the parallel to serial signal converting module comprises a digital circuit and a multiplexer, with the digital circuit comprising at least one flip flop; or the parallel to serial signal converting module comprises a digital circuit comprising at least one flip flop, at least one NAND gate and at least one inverted gate; or the parallel to serial signal converting module comprises a locking data circuit and a multiplexer.

17. The data transmission method of claim 4, wherein the serial to parallel signal converting module comprises a digital circuit and a demultiplexer, with the digital circuit comprising at least one flip flop; or the serial to parallel signal converting module comprises a digital circuit comprising at least one flip flop and at least one AND gate.

18. The data transmission method of claim 6, wherein the serial to parallel signal converting module comprises a digital circuit and a demultiplexer, with the digital circuit comprising at least one flip flop; or the serial to parallel signal converting module comprises a digital circuit comprising at least one flip flop and at least one AND gate.

19. A bus architecture applicable to a signal transmission environment between units, elements, components and devices of an information system, the bus architecture comprising:
a parallel to serial signal converting module comprising a parallel signal input terminal and a serial signal output terminal, wherein the parallel signal input terminal is inputted with a parallel signal from at least one wire, and the parallel to serial signal converting module converts the inputted parallel signal to a serial signal, allowing the serial signal to be outputted by the serial signal output terminal.

20. The bus architecture of claim 19, further comprising:
a serial to parallel signal converting module comprising a serial signal input terminal and a parallel signal output terminal, wherein the serial signal input terminal is inputted with a serial signal from a single wire, and the serial to parallel signal converting module converts the inputted serial signal to a parallel signal, allowing this parallel signal to be outputted by the parallel signal output terminal.

21. The data transmission method of claim 5, wherein the wire is selected from the group consisting of a data wire for transmitting data, an address wire for transmitting addresses, and a control signal wire for transmitting control signals.

22. The data transmission method of claim 12, wherein the parallel to serial signal converting module comprises a digital circuit and a multiplexer, with the digital circuit comprising at least one flip flop; or the parallel to serial signal converting module comprises a digital circuit comprising at least one flip flop, at least one NAND gate and at least one inverted gate; or the parallel to serial signal converting module comprises a locking data circuit and a multiplexer.

23. The data transmission method of claim 11, wherein the serial to parallel signal converting module comprises a digital circuit and a demultiplexer, with the digital circuit comprising at least one flip flop; or the serial to parallel signal converting module comprises a digital circuit comprising at least one flip flop and at least one AND gate.

24. The bus architecture of claim 13 wherein the serial to parallel signal converting module comprises a digital circuit and a demultiplexer, with the digital circuit comprising at least one flip flop; or the serial to parallel signal converting module comprises a digital circuit comprising at least one flip flop and at least one AND gate.

25. The bus architecture of claim 19, wherein the parallel signal inputted to the parallel signal input terminal is obtained from the units, elements, components and devices of the information system or from a parallel signal output terminal of a serial to parallel signal converting module.

26. The bus architecture of claim 20, wherein the serial signal inputted to the serial signal input terminal is obtained from the units, elements, components and devices of the information system or from the serial signal output terminal of the parallel to serial signal converting module.

27. The bus architecture of claim 19, wherein the wire is selected from the group consisting of a data wire for transmitting data, an address wire for transmitting addresses, and a control signal wire for transmitting control signals.

28. The bus architecture of claim 20, wherein the wire is selected from the group consisting of a data wire for transmitting data, an address wire for transmitting addresses, and a control signal wire for transmitting control signals.

29. The bus architecture of claim 19, wherein the parallel to serial signal converting module a digital circuit and a multiplexer, with the digital circuit comprising at least one flip flop; or the parallel to serial signal converting module comprises a digital circuit comprising at least one flip flop, at least one NAND gate and at least one inverted gate; or the parallel to serial signal converting module comprises a locking data circuit and a multiplexer.

30. The bus architecture of claim 20, wherein the serial to parallel signal converting module comprises a digital circuit and a demultiplexer, with the digital circuit comprising at least one flip flop; or the serial to parallel signal converting module comprises a digital circuit comprising at least one flip flop and at least one AND gate.
